(19) United States
(12) Patent Application Publication
(10) Pub. No.: US 2013/0166469 A1
(43) Pub. Date: Jun. 27, 2013

(54) TRANSPORTATION RATES EVALUATION

(71) Applicant: SUDHINDRA CHANDRASHEKAR, Bangalore (IN)

(72) Inventor: SUDHINDRA CHANDRASHEKAR, Bangalore (IN)

(21) Appl. No.: 13/335,988

(22) Filed: Dec. 23, 2011

(51) Int. Cl. G06Q 30/00

(52) U.S. Cl. 705/335

(57) ABSTRACT

A through rate evaluation processing is done by breaking down a transportation network to transportation stages and then a master data is scanned for the rates of the transportation stages. The complete network is evaluated recursively to get the rates and a calculation is performed to get the best rates.

### FIELD

The invention relates to transportation management. More precisely, the field relates to evaluation of transportation rates.

### BACKGROUND

The commercial transportation requires goods to be moved from one place to another. However, the transportation does not happen by moving the goods directly from a shipper location to a consignee location. There may be numerous stops in between. These stops form different stages from the transport start location to the transport end location. The different stages may comprise shorter or longer distances from the whole shipment process. For example, a pick-up stage is followed by a pre-carriage stage to an export station. Then a main carriage stage moves the goods from the export station to an import station. An on-carriage stage then moves the goods from the import station to a consignee and the last stage may be the actual delivery.

In the logistic service provider (LSP) market, the freight costing can be very dynamic. 80% of the freight costing is based on location pairs, which means per stage. Agreements can be set up between a LSP and a customer (e.g., a shipper or a consignee) in a way that the rates for the longest distance can be cheaper than the rates per stage. The per stage rates are typically applicable in case of orders for shorter distances. In case of longer distances, the rates can be completely different even though the route taken is via the individual stages. So if there is a shipment in the following route A->B->C->D, then the rate between A->D can be cheaper than the summation of the rates between A->B, B->C, and C->D. It can also happen that the rates are set up for A->C and C->D or A->B and B->D, which is still cheaper than the rates between A->B, B->C, and C->D.

### SUMMARY

Various embodiments of systems and methods for transportation rates evaluation are described herein. In one embodiment, the method includes receiving a transport start location, a transport end location, and one or more intermediate stops between the transport start location and the transport end location, wherein the intermediate stops form a plurality of stages from the transport start location to the transport end location. The method also includes determining the plurality of stages from the transport start location to the transport end location and scanning a master data for transportation rates between the transport start location and the transport end location by checking recursively the plurality of stages. The method further includes evaluating the transportation rates for transportation from the transport start location to the transport end location.

In other embodiments, the system includes a processor for executing program code and memory. The system also includes a receiving module to receive a transport start location, a transport end location, and one or more intermediate stops between the transport start location and the transport end location, wherein the intermediate stops form a plurality of stages from the transport start location to the transport end location. The system further includes a determinator module to determine the plurality of stages from the transport start location to the transport end location and a scanning module to scan a master data for transportation rates between the transport start location and the transport end location by checking recursively the plurality of stages. The system further includes an evaluator module to evaluate the transportation rates for transportation from the transport start location to the transport end location.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram representing a transportation network formed between a transport start location and a transport end location, according to one embodiment.

FIG. 2 is a flow diagram of an embodiment of a method for transportation rates evaluation.

FIG. 3 is a block diagram of an embodiment of a system for transportation rates evaluation.

FIG. 4 is a block diagram of an embodiment of a system for transportation rates evaluation.

FIG. 5 is a block diagram of an embodiment of a system for transportation rates evaluation.

FIG. 6 is a block diagram illustrating a computing environment in which the techniques described for transportation rates evaluation can be implemented, according to an embodiment.

### DETAILED DESCRIPTION

Embodiments of techniques for transportation rates evaluation are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

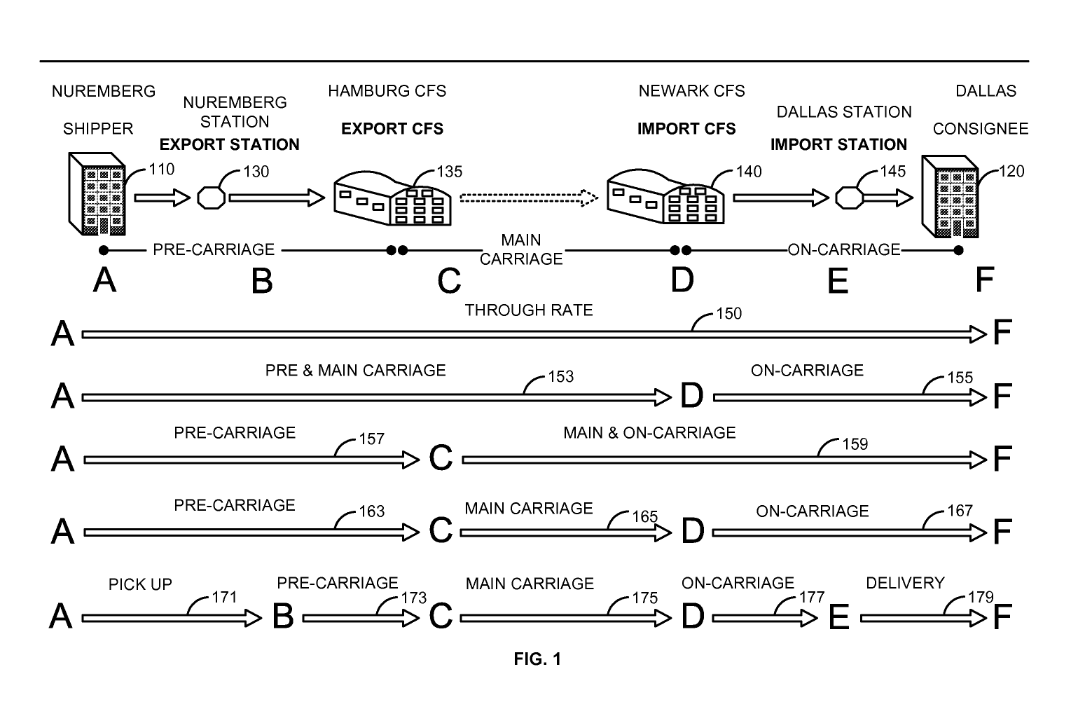

FIG. 1 represents a block diagram of a transportation network formed between a transport start location and a transport end location. The network includes a transport start location A 110, which is a shipper location and a transport end location F 120, which is a consignee location. For example, the shipper A 110 is located in Nuremberg, Germany and the consignee F 120 is located in Dallas, USA. The goods are not shipped directly from the transport start location A 110 to the transport end location F 120. There may be numerous stops, such as B 130, C 135, D 140, and E 145. These stops form a transportation network from the transport start location A to the transport end location F. The stops may also be referred to as stages or legs. The shipment from transport start location A 110, which is a shipper location, to a container freight station (CFS), which is the export CFS C 135 in Hamburg, may be referred to as pre-carriage. The shipment between the export CFS C 135 to the import CFS D 140 in Newark, may be referred to as main carriage, and the shipment from the Import CFS D 140 to the transport end location F 120 in Dallas, as on-carriage. If a shipment from the transport start location A 110 to the transport end location F 120 happens often, then there might be a through rate defined by the LSP. The through rate is a direct rate from A to F 150, without considering the intermediate stops. There might also be other rates given by the LSP to charge for the shipment, for example A to D 153, which combines pre-carriage and main carriage stages, and then D to F 155, which is the on-carriage stage or A to C 157, which is a pre-carriage stage and then C to F 159, which combines the main carriage and on-carriage stages. Another possibility is A to C 163 (pre-carriage), then C to D 165 (main carriage), and finally D to F 167 (on-carriage). The most granular level is A to B 171 (pick-up), B to C 173 (pre-carriage), C to D 175 (main carriage), D to E 177 (on-carriage), and E to F 179 (delivery). These are the different ways in which the pricing can be determined dynamically. The calculation of the charges may also be dynamic. According to one embodiment, the complete network is broken down to the most granular level and then a master data provided by the LSP is scanned for rates of the different stages. Initially, the master data is scanned for rate between A to F 150, and if it is not found, the master data is scanned for the next best combination until reaching the most granular level. Checking the whole network recursively ensures determining the best rate available.

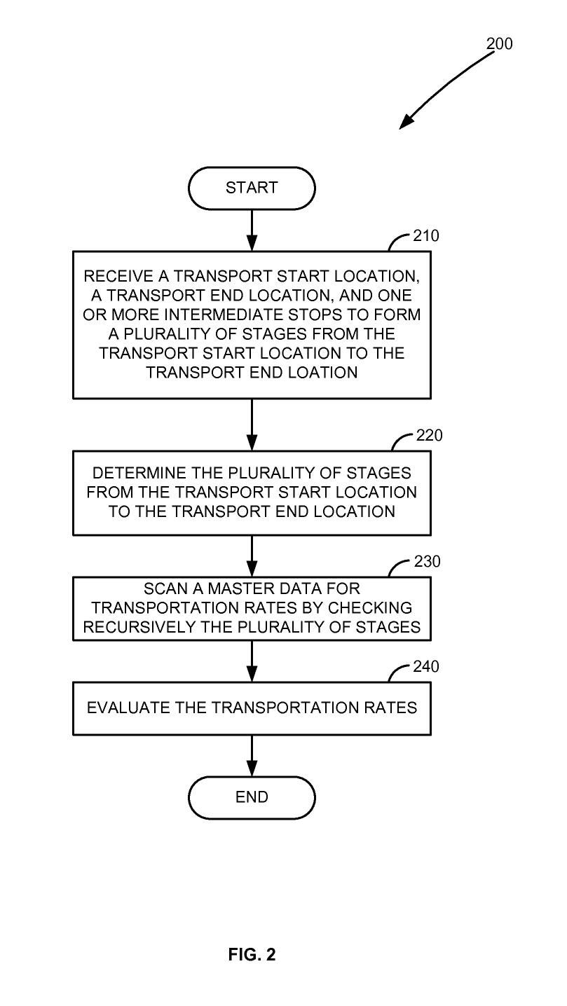

FIG. 2 is a flow diagram of an embodiment of a method 200 for transportation rates evaluation. The method begins at block 210 with receiving a transport start location, a transport end location, and one or more intermediate stops between the transport start location and the transport end location, wherein the intermediate stops form a plurality of stages from the transport start location to the transport end location. In one embodiment, the transport start location, the transport end location, and the plurality of stages are received from a transportation request. Typically, a transportation request comes from the consignee or the shipper of the goods. The transportation request, which may also be referred to as a forwarding order, is intended for a logistic service provider (LSP).

Turning back to FIG. 2, at block 220, the plurality of stages are determined between the transport start location and the transport end location. The intermediate stops form the stages from the transport start location to the transport end location. The plurality of stages from the transport start location to the transport end location form a transportation network from the transport start location to the transport end location. A single stage may have its own pricing, as well as there may be pricing for several consecutive stages. For example, in the transportation network presented in FIG. 1, there may be individual pricing for the stages A to B 171, B to C 173, and C to D 175, but also a combined rate A to D 153. Typically, a combined rate is of lower value than the summation of several consecutive stage rates covering the same distance. Then, at block 230, a master data is scanned for available transportation rates between the transport start location and the transport end location by checking recursively the plurality of stages. In one embodiment, the scanning starts with searching for a through rate for direct shipping from the transport start location to the transport end location. The reason for this is that if such a rate exists in the master data, according to one embodiment, this rate is most likely the lowest rate for transportation from the transport start location to the transport end location. For example, such direct shipping with a through rate is presented in FIG. 1, A to F 150. Then the scan proceeds with searching for stage rates for the whole transportation network from the transport start location to the transport end location. Thus, the whole transportation is scanned for possible routes from the transport start location to the transport end location either by no intermediate stop or with one or more intermediate stops. For example, in FIG. 1, there may be a rate available for a direct shipping A to F 150, but also alternatives such as A to D 153 and D to F 155 or A to C 163, C to D 165, and D to F 167.

Turning back to FIG. 2, the transportation rates for transportation from the transport start location to the transport end location are evaluated in block 240. The evaluation goal is finding a rate from transport start location to the transport end location. In one embodiment, evaluating the transportation rates includes calculation of a basic transportation charge. In another embodiment, evaluating the transportation rates includes calculation of a set of sub-charges. In one embodiment, the sub-charges may include a basic charge, insurance charge, loading charge, and unloading charge.

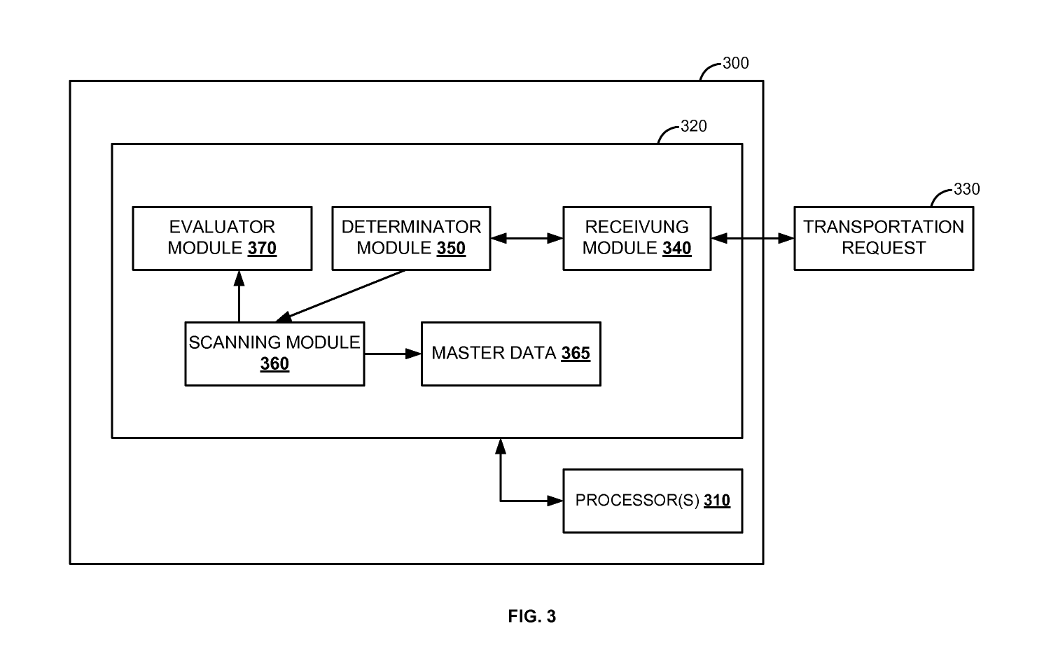

FIG. 3 is a block diagram of an embodiment of a system 300 for transportation rates evaluation. The system includes one or more processors 310 for executing program code. Computer memory 320 is in communication with the one or more processors 310. The system 300 further includes a receiving module 340 within the memory 320, to receive a transport start location, a transport end location, and one or more intermediate stops between the transport start location and the transport end location, wherein the intermediate stops form a plurality of stages from the transport start location to the transport end location. In one embodiment, the transport start location, the transport end location and the plurality of stages are received from a transportation request 330. The transportation request 330 is triggered by a shipper or a consignee. A determinator module 350, within the memory 320, is in communication with the receiving module 340 and the determinator module 350 is operable to determine the plurality of stages from the transport start location to the transport end location received by the receiving module 340. The intermediate stops form a plurality of stages from the transport start location to the transport end location. The plurality of stages forms a transportation network from the transport start location to the transport end location. The stages may have their own pricing or such pricing may not be available. The available pricing defines the possible routes, either direct or using intermediate stops from the transport start location to the transport end location.

The memory 320 also includes a scanning module 360. The scanning module 360 is operable to scan a master data 365 for transportation rates between the transport start location and the transport end location. The master data 365 may be within the system 300 or external (not shown) to the system 300. In one embodiment the scanning module 360 searches the master data 365 for a through rate for direct shipping from the transport start location to the transport end location and then searches for stage rates for the plurality of stages from the transport start location to the transport end location. The whole transportation network from the transport start location to the transport end location is checked recursively by scanning the master data 365. Thus the transportation rates for the possible routes from the transport start location to the transport end location are extracted.

An evaluator module 370, within the memory 320, is in communication with the scanning module 360 and the evaluator module 370 is operable to evaluate the transportation rates for the transportation from the transport start location to the transport end location. In one embodiment, the evaluator module is operable to calculate a basic transportation charge. In one embodiment, the evaluator module is operable to calculate a set of sub-charges. In one embodiment, the set of sub-charges may include a basic charge, insurance charge, loading charge, and unloading charge.

The various modules, their respective functionality and location as discussed in relation to FIG. 3 is an exemplary embodiment and one skilled in the art will understand that other embodiments are possible by combining the functionalities into fewer modules or even further dispersing the functionalities into more modules.

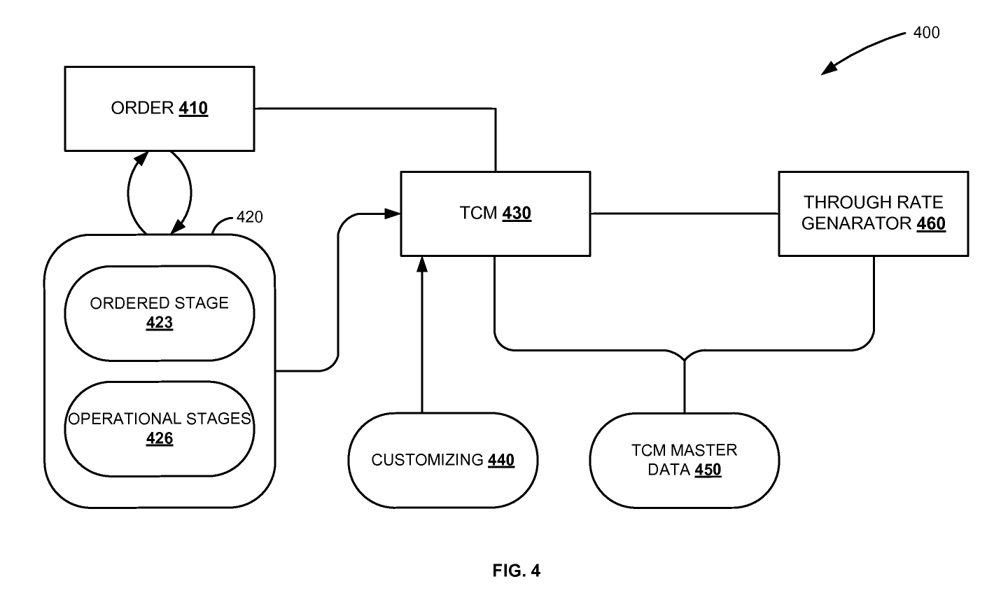

FIG. 4 is a block diagram of an embodiment of a system 400 for transportation rates evaluation. Order 410 is generated by a shipper or a consignee. The order 410 includes information for the transport start location and the transport end location. The stages 420 are captured within the order 410. The ordered stage 423 is the direct route from the transport start location to the transport end location, for example A to F 150 in FIG. 1. Operational stages 426 are planned/actual routes from the transport start location to the transport end location, for example the route A to C 157 and C to F 159 in FIG. 1. The transport start and transport end locations, which define the ordered stage 423, as well as the operational stages 426 are gathered in a transportation charge management (TCM) block 430. The TCM block 430 is responsible for the charge calculation of the stages 420. The TCM block 430 receives customization 440. The customization 440 is referred to which stage from the stages 420 to be considered for the charge calculation by the TCM block 430. Accordingly, the TCM block 430 may check the ordered stage 423 only and skip the alternative operational stages 426. In one embodiment, both the ordered stage 423 and the operational stages 426 are considered by the TCM block 430 for the charge calculation. In connection to the customization 440, the TCM block 430 searches the TCM master data 450 for rates of the stages 420 and then processes the stage rates to get the alternatives for the transportation from the transport start location to the transport end location. The through rate generator 460 uses the information from the TCM block 430 and evaluates the rate from the transport start location to the transport end location. The TCM block 430 then presents the rate as an output for the shipment from the transport start location to the transport end location.

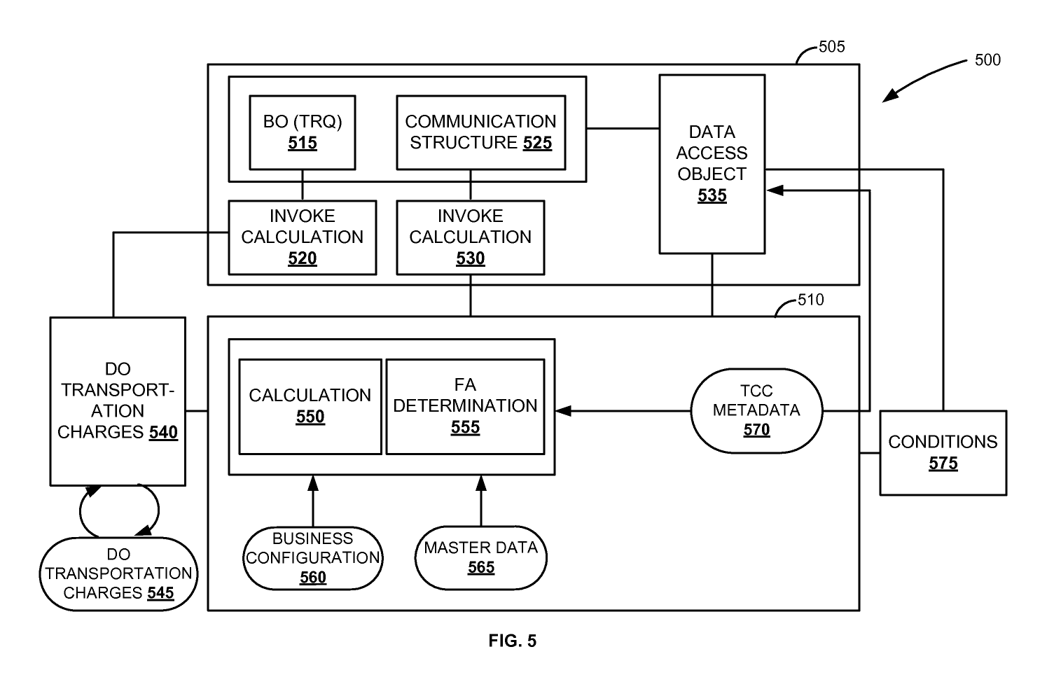

FIG. 5 is a block diagram of an embodiment of a system 500 for transportation rates evaluation. System 500 includes two major blocks: a consumer's block 505 and a calculation engine 510. The consumer's block 505 refers to data and data organization gathered from or presented to the consumers of the evaluation process performed by the system 500 for transportation rates evaluation. Consumers of an evaluation process are typically a shipper or a consignee. The consumer's block 505 includes a business object (BO) 515 and a communication structure 525. The BO 515 may be, for example, a transportation request (TRQ). Hence, a BO 515 typically includes information for transportation such as a transport start location, a transport end location and the actual/operational routes. Presence of BO 515 invokes calculation through the invoke calculation block 520 and invoke calculation block 530. The calculation engine 510 is responsible for evaluating transportation rates according to the BO 515 triggered by a consumer. The calculation engine 510 accesses the data from the BO 515 through the data access object (DAO) 535. The DAO 535 has access to the communication structure 525. In one embodiment, the communication structure 525 is a service interface provided to the consumer. During the evaluation process, the communication structure 525 may change to represent the evaluated rates. In that case, the blocks transportation charge calculation (TCC) metadata 570 and conditions 575 may participate. The TCC metadata includes data for the evaluated data to be presented and the conditions 575 include information about the business rules taken into consideration during the evaluation process. The calculation engine 510 is operable to determine a forwarding agreement (FA) through FA determination block 555. The FA determination block 555 scans master data 565 for forwarding agreements, tariffs, etc. Then, processing the FA is part of the evaluation process performed by the calculation block 550. The evaluation done by the calculation block 550 may be also affected by a business configuration block 560. The business configuration block 560 includes business customization for what data from the master data 565 to be considered for evaluating the transportation rates. Output (evaluated results) from the calculation engine 510 may be persisted in dependent objects (DO) DO transportation charges 540 and DO transportation charges 545. The evaluated results may be transferred for representation to the consumer's block 505 through the communication structure 525 as explained above.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

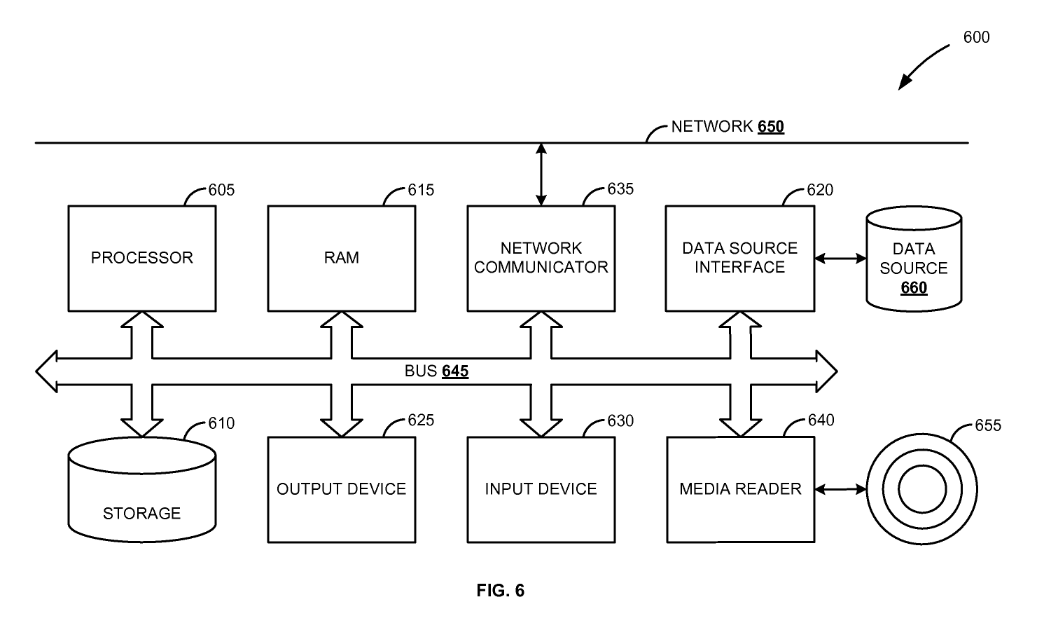

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to compare transportation rates, comprising:
receiving a transport start location, a transport end location, and one or more intermediate stops between the transport start location and the transport end location, wherein the one or more intermediate stops form a plurality of stages from the transport start location to the transport end location;
determining the plurality of stages from the transport start location to the transport end location;
scanning a master data for transportation rates between the transport start location and the transport end location by checking recursively the plurality of stages from the transport start location to the transport end location; and
evaluating the transportation rates for transportation from the transport start location to the transport end location.

2. The method of claim 1, wherein receiving the transport start location, the transport end location and the plurality of stages further comprises receiving the transport start location, the transport end location and the plurality of stages from a transportation request.

3. The method of claim 1, wherein the plurality of stages form a transportation network from the transport start location to the transport end location.

4. The method of claim 1, wherein scanning the master data for the transportation rates further comprises:
searching for a through rate for a direct shipping from the transport start location to the transport end location; and
searching for stage rates for the plurality of stages from the transport start location to the transport end location.

5. The method of claim 1, wherein evaluating the transportation rates further comprises calculating a basic transportation charge.

6. The method of claim 1, wherein evaluating the transportation rates further comprises calculating a set of sub-charges.

7. The method of claim 6, wherein the set of sub-charges comprises one or more of the group consisting of a basic charge, insurance charge, loading charge, and unloading charge.

8. A computer system for transportation rates comparison comprising:
a processor; and
a memory in communication with the processor, the memory storing instructions related to:
a receiving module to receive a transport start location ,a transport end location, and one or more intermediate stops between the transport start location and the transport end location, wherein the one or more intermediate stops form a plurality of stages from the transport start location to the transport end location;
a determinator module to determine the plurality of stages from the transport start location to the transport end location;
a scanning module to scan a master data for transportation rates between the transport start location and the transport end location by checking recursively the plurality of stages from the transport start location to the transport end location; and
an evaluator module to evaluate the transportation rates for transportation from the transport start location to the transport end location.

9. The system of claim 8 wherein the receiving module is further operable to receive the transport start location, the transport end location and the plurality of stages from a transportation request.

10. The system of claim 8, wherein the plurality of stages form a transportation network from the transport start location to the transport end location.

11. The system of claim 8, wherein the scanning module is further operable to:
search for a through rate for a direct shipping from the transport start location to the transport end location; and
search for stage rates for the plurality of stages from the transport start location to the transport end location.

12. The system of claim 8, wherein the evaluator module is further operable to calculate a basic transportation charge.

13. The system of claim 8, wherein the evaluator module is further operable to calculate a set of sub-charges.

14. An article of manufacture including a non-transitory computer readable storage medium to tangibly store instructions, which when executed by a computer, cause the computer to:
receive a transport start location, a transport end location, and one or more intermediate stops between the transport start location and the transport end location, wherein the one or more intermediate stops form a plurality of stages from the transport start location to the transport end location;
determine the plurality of stages from the transport start location to the transport end location;
scan a master data for transportation rates between the transport start location and the transport end location by checking recursively the plurality of stages from the transport start location to the transport end location; end
evaluate the transportation rates for transportation from the transport start location to the transport end location.

15. The article of manufacture of claim 14, wherein the instructions to receive a transport start location, a transport end location, and the plurality of stages further comprise instructions, which when executed by a computer, cause the computer to receive the transport start location , the transport end location and the plurality of stages from a transportation request.

16. The article of manufacture of claim 14, wherein the plurality of stages form a transportation network from the transport start location to the transport end location.

17. The article of manufacture of claim 14, wherein the instructions to scan a master data for transportation rates between the transport start location and the transport end location further comprise instructions, which when executed by a computer, cause the computer to:
search for a through rate for a direct shipping from the transport start location to the transport end location; and
search for stage rates for the plurality of stages from the transport start location to the transport end location.

18. The article of manufacture of claim 14, wherein the instructions to evaluate the transportation rates further comprise instructions, which when executed by a computer, cause the computer to calculate a basic calculation charge.

19. The article of manufacture of claim 14, wherein the instructions to evaluate the transportation rates further comprise instructions, which when executed by a computer, cause the computer to calculate a set of sub-charges.

20. The article of manufacture of claim 19, wherein the set of sub-charges comprises one or more of the group consisting of a basic charge, insurance charge, loading charge, and unloading charge.
